(19) United States
(12) Patent Application Publication
(10) Pub. No.: US 2023/0088242 A1
(43) Pub. Date: Mar. 23, 2023

(54) SOLUTION FOR CONTROLLING PASSENGER FLOW

(71) Applicant: KONE Corporation, Helsinki (FI)

(72) Inventors: Salla MANNERJOKI, Helsinki (FI); Janne SORSA, Helsinki (FI); Mikko KONTTURI, Helsinki (FI); Seppo NUMMINEN, Helsinki (FI); Jörn WIENHOLZ-BUß, Helsinki (FI)

(73) Assignee: KONE Corporation, Helsinki (FI)

(21) Appl. No.: 18/072,853

(22) Filed: Dec. 1, 2022

Related U.S. Application Data
(63) Continuation of application No. PCT/FI2020/050431, filed on Jun. 16, 2020.

(51) Int. Cl. B66B 1/24; B66B 1/20; B66B 1/34

(52) U.S. Cl. CPC B66B 1/2458; B66B 1/20; B66B 1/3446

(57) ABSTRACT

A method for controlling a passenger flow in a building includes: dividing a group of elevators to sub-groups; receiving a service call; selecting a sub-group to provide a service and generating an indication for indicating the selected sub-group; selecting a first candidate elevator; evaluating a second candidate elevator by comparing the second forecast time to the first forecast time; selecting the second candidate elevator to provide the service if the second forecast time is less than the first forecast time. The evaluation is continued until a selection is locked for the service call due to at least one characteristic relating to the elevator system. The invention also relates to a group controller, a computer program product, and an elevator system.

### TECHNICAL FIELD

The invention concerns in general the technical field of elevators. More particularly, the invention concerns a solution of serving passengers by an elevator system.

### BACKGROUND

Elevator allocation is an important operation in elevator systems in terms of service quality and user satisfaction. In traditional elevator systems in which a passenger provides a service call with a call giving button an elevator controller generates a control signal to the elevator system to accomplish the service call and as a result an elevator car arrives at a floor from which the service call was given by the passenger requesting service from the elevator system. The traditional mechanism works well especially in buildings being small and not having too many floors, which means that elevator resources are quite small, e.g. there is only one elevator serving the passengers.

In large buildings the service calls may be given so that a destination floor is provided in the service call. In other words, the elevator system comprises a service call giving interface through which the passenger provides the destination where he/she is willing to travel with the elevator, i.e. the destination floor as mentioned. The elevator controller performs an allocation of an elevator car to serve the service call i.e. the passenger, which is then indicated to the passenger in one way or another. For example, the elevator system may indicate the elevator to the passenger through the service call giving interface, e.g. by displaying an identifier of the elevator among a plurality of elevators belonging to the elevator system so that the passenger may look for the identifier from the floor, or hall, area e.g. illustrated on a wall.

However, in large buildings comprising a plurality of elevators belonging to the elevator systems the allocation of elevators, and elevator cars, for serving the passengers may be improved to. It is especially important that the passengers are guided to the serving elevators in an efficient manner even if a selection of the serving elevator may change after the service call is given. The present invention is addressed to provide solutions for the described area.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, a group controller, a computer program product, and an elevator system for controlling a passenger flow.

The objects of the invention are reached by a method, a group controller, a computer program product, and an elevator system as defined by the respective independent claims.

According to a first aspect, a method for controlling a passenger flow in a building comprising a group of elevators belonging to an elevator system is provided, the method, performed by a group controller of the elevator system, comprises: dividing the group of elevators to sub-groups of elevators; receiving a service call; selecting a sub-group among the sub-groups of elevators to provide a service for the service call and generating an indication for indicating the sub-group selected for the service call; selecting a first candidate elevator from the elevators of a selected sub-group to provide the service for the service call within a first forecast time; evaluating a second candidate elevator from the elevators of a selected sub-group to provide the service for the service call within a second forecast time by comparing the second forecast time to the first forecast time; selecting the second candidate elevator from the elevators of a selected sub-group to provide the service for the service call if the second forecast time is less than the first forecast time; wherein the method the evaluation is continued until a selection of the candidate elevator is locked for the service call due to at least one characteristic relating to the elevator system.

For example, a selection of the sub-group among the sub-groups of elevators to provide a service may be performed based on at least one of: a destination floor indicated in the service call; identification of a user or a user group from data associated to the service call; identification of a service call giving device wherefrom the service call is received; allocations status of service calls between the sub-groups of elevators; a prediction model defining a selection of the sub-group of elevators.

The method may further comprise: generate a control signal to cause an indication for indicating the locked candidate elevator selected from the elevators of the selected sub-group to serve the service call. For example, the indication may be caused to be generated at least by an elevator indicator of candidate elevator locked for the service.

The at least one characteristic relating to the elevator system may be at least one of: a deceleration of the elevator car of the candidate elevator is initiated; a predefined advance indication time defining an instant of time prior to a landing of the elevator car of the candidate elevator the indication for indicating the locked candidate elevator is generated.

Moreover, a division of the group of elevators to sub-groups may be performed as at least one of: static configuration for the elevator system; dynamically.

A generation of the indication of the sub-group may be performed by causing an output of the indication by at least one of: an elevator call giving device; a sub-group indicator.

According to a second aspect, a group controller of an elevator system comprising a group of elevators is provided, the group controller is arranged to perform: divide the group of elevators to sub-groups of elevators; receive a service call; select a sub-group among the sub-groups of elevators to provide a service for the service call and generating an indication for indicating the sub-group selected for the service call; select a first candidate elevator from the elevators of a selected sub-group to provide the service for the service call within a first forecast time; evaluate a second candidate elevator from the elevators of a selected sub-group to provide the service for the service call within a second forecast time by comparing the second forecast time to the first forecast time; select the second candidate elevator from the elevators of a selected sub-group to provide the service for the service call if the second forecast time is less than the first forecast time; wherein the group controller is arranged to continue an evaluation until a selection of the candidate elevator is locked for the service call due to at least one characteristic relating to the elevator system.

For example, the group controller may further be arranged to perform a selection of the sub-group among the sub-groups of elevators to provide a service based on at least one of: a destination floor indicated in the service call; identification of a user or a user group from data associated to the service call; identification of a service call giving device wherefrom the service call is received; allocations status of service calls between the sub-groups of elevators; a prediction model defining a selection of the sub-group of elevators.

The group controller may further be arranged to perform: generate a control signal to cause an indication for indicating the locked candidate elevator selected from the elevators of the selected sub-group to serve the service call. For example, the indication may be caused to be generated at least by an elevator indicator of candidate elevator locked for the service.

Moreover, the at least one characteristic relating to the elevator system may be at least one of: a deceleration of the elevator car of the candidate elevator is initiated; a predefined advance indication time defining an instant of time prior to a landing of the elevator car of the candidate elevator the indication for indicating the locked candidate elevator is generated.

Still further, the group controller may further be arranged to perform a division of the group of elevators to sub-groups as at least one of: static configuration for the elevator system; dynamically.

The group controller may further be arranged to perform a generation of the indication of the sub-group by causing an output of the indication by at least one of: an elevator call giving device; a sub-group indicator.

According to a third aspect, a computer program product is provided, the computer program product comprising computer readable program code configured to cause performing the method according to the first aspect as described above when said program code is run on one or more computing apparatuses.

According to a fourth aspect, an elevator system is provided, the elevator system comprising: a group of elevators, and a group controller according to the second aspect as described above.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features.

The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an elevator system according to an example.

FIG. 2 illustrates schematically a method according to an example.

FIG. 3 illustrates schematically a group controller according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

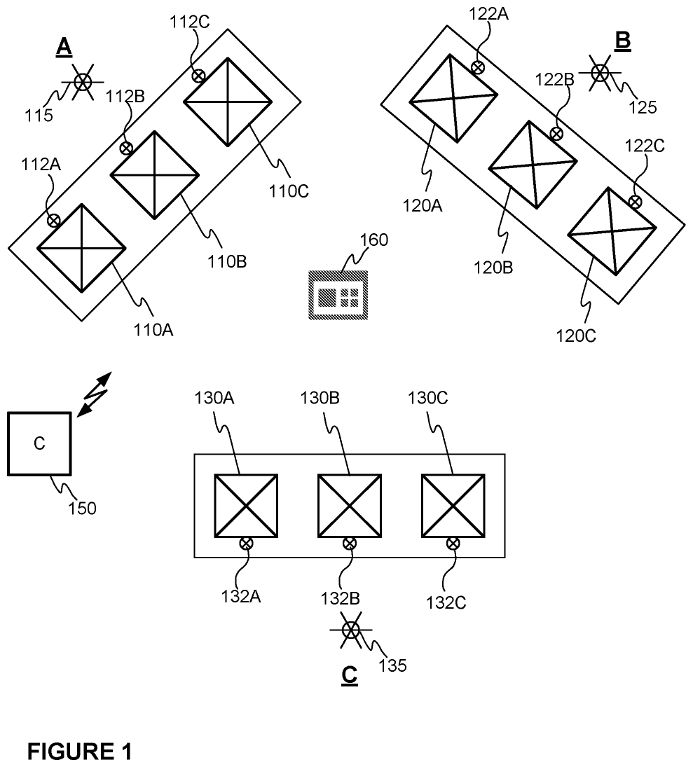

FIG. 1 illustrates schematically an elevator system into which the present invention may be implemented to. The elevator system may comprise a group of elevators 110A, 110B, 110C, 120A, 120B, 120C, 130A, 130B, 130C which are arranged to serve passengers in a location, such as in a building. For example, the elevators 110A-110C, 120A-1200, 130A-130C may be such that there travels one elevator car in each, and service calls are allocated to the elevators 110A-110C, 120A-1200, 130A-130C in a manner as will be described. In accordance with some example embodiments the group of elevators 110A-110C, 120A-1200, 130A-1300 may be controlled by a group controller 150 which may be communicatively connected to the elevators 110A-1100, 120A-120C, 130A-130C so as to enable controlling an operation of the elevators 110A-110C, 120A-1200, 130A-130C at least in part, e.g. for managing and controlling a passenger flow in the building.

In accordance with at least some example embodiments the group of elevators 110A-1100, 120A-120C, 130A-130C may be divided to sub-groups of elevators 110A-1100, 120A-1200, 130A-130C. The sub-groups are referred with characters A, B, and C in FIG. 1. The sub-groups A, B and C may be formed in a static manner or dynamically according to a predetermined sub-grouping plan. The sub-grouping may e.g. be based on physical location of the elevators or in any other applicable manner.

Moreover, the elevator system may comprise indicators for providing signals e.g. visually or audibly to passengers in order to give guidance to the passengers. More specifically, the indicators may refer to lanterns, gongs, displays or anything similar to serve the purpose. The indicators may be arranged so that there is arranged one or more indicators to represent a sub-group A, B, C. These indicators are referred with 115 for sub-group A, with 125 for sub-group B and with 135 for sub-group C in FIG. 1. The sub-group indicators 115, 125, 135 may be used for indicating the sub-group to a passenger in a manner as will be described in the forthcoming description. Still further, an elevator indicator may be arranged for each elevator. These are referred with 112A, 112B, 112C for the elevators 110A, 110B, 110C respectively, with 122A, 122B, 122C for the elevators 120A, 120B, 120C respectively and with 132A, 132B, 132C for the elevators 130A, 130B, 130C respectively in FIG. 1. The elevator indicators 112A-1120, 122A-122C, 132A-132C may be used for indicating an elevator to the passenger as will be described in the forthcoming description.

Still further, there may be arranged one or more service call giving devices 160, such as a destination operating panels, in one or more locations to allow passengers to give service calls to the elevator system. For example, the service call giving device 160 may be a touch screen device. The service call giving device 160 may also be a terminal device carried by the passenger, such as a mobile terminal, and the terminal device may be arranged to execute a computer program product for interacting with the elevator system to give service calls with the terminal device. The service call giving devices 160 may be communicatively connected to other entities, such as to the group controller 150.

In accordance with some example embodiments the elevator environment as described above and in FIG. 1 may be arranged in a plurality of floors in the building.

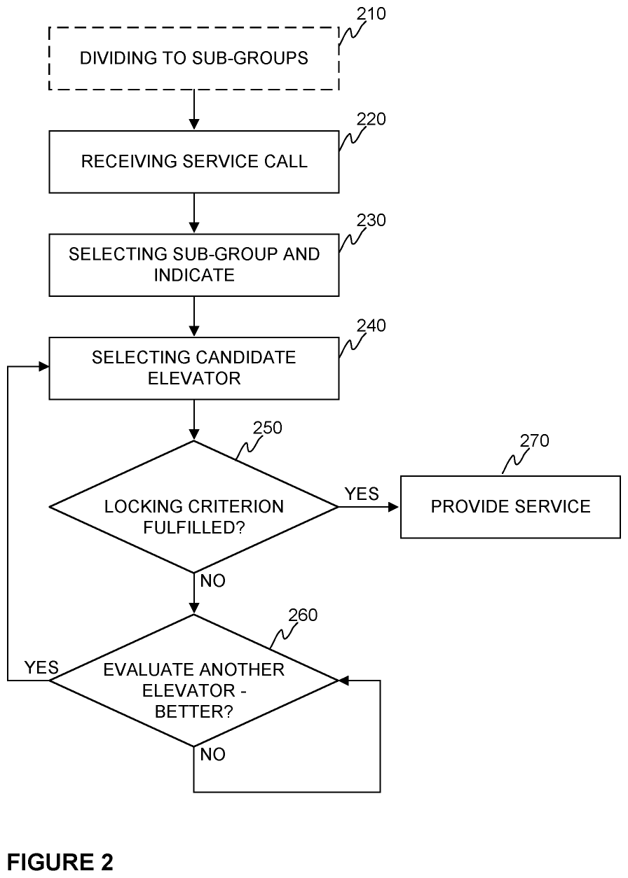

Next, further aspects of the invention are now described by referring to FIG. 2 schematically illustrating a method according to an example embodiment. Depending on an implementation of the elevator system in some example embodiments the method may be initiated by dividing 210 elevators belonging to a group implementing the elevator system to sub-groups. This kind of division may be performed as a basic configuration for the elevator system as a static configuration, but it may also be defined dynamically e.g. based on some predetermined criteria or model, such as overall amount of people in the building, or in any other manner as is discussed in the forthcoming description.

At some point, the elevator system may receive 220 a service call from a person who needs service from the elevator system. The service call may be given e.g. through a service call giving device 160. For the purpose of describing at least some aspects of the invention it is hereby assumed that the service call indicates a destination floor the passenger is willing to travel to. The service call is received by the group controller 150 which determines at least the destination floor from the service call and selects 230 a sub-group A, B, C to serve the service call. The selection may e.g. be based on a predetermined plan defining the floors served by each sub-group A, B, C or to any other decision-making process, such as a service plan defining that certain users or user groups are served by one or more predefined sub-groups A, B, C which user or user group may be identified based on data associated to the service call. Moreover, the selection of the sub-group A, B, C may be based on identifying the service call giving device 160 through which the service call is generated and select at least one sub-group A, B, C associated to the service call giving device 160 in question e.g. based on a location of the service call giving device 160 e.g. with respect to the sub-group A, B, C. Alternatively or in addition, the selection of the sub-group A, B, C may be based on allocation status of pending service calls between the sub-groups A, B, C and in accordance with a predefined rule an optimal sub-group A, B, C is selected for serving the new service call. Still further, in some example embodiment the sub-groups A, B, C of elevators may change dynamically e.g. based on a prediction model established for the group of elevators. The prediction model may e.g. be established on a basis of statistics e.g. representing utilization rate of the elevators in the past i.e. history data. In some embodiments it may be arranged that the prediction model changes, and, hence, the allocation of service calls between the sub-groups A, B, C, at predefined intervals in time.

In response to the selection 230 the elevator system may generate an indication 230 on the sub-group to the passenger. According to an example the indication may be output with the service call giving device 160, such as displaying an output indicating the selected sub-group A, B, C. Alternatively or in addition, the group controller 150 may generate a control signal to a sub-group indicator 115, 125, 135 corresponding to the selection. According to an embodiment, the indication of the sub-group A, B, C may be arranged so that the outputs in the service call giving device 160 and an output of the sub-group indicator 115, 125, 135 are aligned together. For example, in case both entities are displays, it may be arranged that a similar image is shown on both of these so as to attract the passenger's attention. Any other outputting mechanisms and methods may be applied to. The procedure as described above may achieve the passenger to move in a vicinity of the selected sub-group A, B, C.

Furthermore, the group controller 150 may be arranged, in response to the selection of the sub-group A, B, C, to initiate a selection of an elevator 110A-110C, 120A-1200, 130A-1300 among the elevators 110A-110C, 120A-1200, 130A-130C of the selected sub-group A, B, C to provide service to the service call in question. The group controller 150 may e.g. perform the selection by selecting 240 a first candidate elevator 110A-110C, 120A-120C, 130A-1300 from the elevators 110A-110C, 120A-1200, 130A-1300 of the selected sub-group A, B, C to provide the service for the service call within a first forecast time. The first forecast time refers to a time, or to a predefined comparison value representing the time either directly or indirectly, how long it takes from the selected first candidate elevator 110A-110C, 120A-1200, 130A-1300 to provide the service for the service call in terms of predefined criteria. In other words, the selection of the first candidate elevator 110A-110C, 120A-1200, 130A-130C may be performed based on a predefined prediction model taking into account some predefined parameters, such as waiting time, travel time, energy consumption, or any combination of these. Further, the forecast time, i.e. the first forecast time and any other forecasts times, may be obtained from a routing model applying predefined rules, such as taking into account previous landings due to already allocated service calls for the candidate elevator before providing the service to the service call in question, for determining an estimated time of arrival (ETA) of the elevator at the landing as the first forecast time to serve the service call. Depending on an implementation the first forecast time, and, hence, the ETA, may represent either a waiting time or a travel time in accordance if the service call represents a landing call or a destination call.

When the candidate elevator 110A-110C, 120A-120C, 130A-130C, such as the first candidate elevator 110A-110C, 120A-1200, 130A-130C is selected 240 the group controller 150 may be arranged to monitor if one or more predetermined criteria are fulfilled or not 250. The predetermined criteria may e.g. represent one or more characteristics relating to the elevator system. In other words, the criterion may e.g. define a time window for re-selecting another candidate elevator 110A-110C, 120A-1200, 130A-130C instead of the first selection, i.e. the first candidate elevator. In accordance with some example embodiment the critenon may e.g. be an instant of time the candidate elevator needs to initiate a deceleration of the elevator car of the candidate elevator 110A-110C, 120A-120C, 130A-130C. In other words, when the elevator car is approaching the floor where the passenger in question resides, it needs to start deceleration in accordance with the characteristics relating to the elevator system so as to follow predefined rules, such as safety standards. If the deceleration needs to be initiated, the candidate elevator being selected at that instant of time is locked to serve the service call i.e. the service is provided 270 to the passenger by the selected candidate elevator in question. Alternatively or in addition, the criterion may relate to timing to provide an indication to the passenger e.g. so as to maintain a desired level of efficiency in the people flow. This kind of characteristic relate to an idea that advantageously an indication of the selected elevator is provided to the passenger in advance the elevator car enters the floor so as to enable the passenger to move in a vicinity of a door of the elevator in question. Hence, the characteristic relating to the elevator system may be a predefined advance indication time defining an instant of time prior to a landing of the elevator car of the candidate elevator the indication for indicating the selected elevator is generated to the passenger. The indication may e.g. refer to an activation of a respective elevator indicator 112A, 112B, 112C, 122A, 122B, 122C, 132A, 1326, 132C. In other words, in step 250 it is determined if there is need to lock the elevator for providing the service and if that is the case the candidate elevator at that instant of time is locked to provide the service for the passenger 270.

However, if it is determined in step 250 that the locking of the candidate elevator has not occurred, the group controller 150 may be arranged to evaluate 260 a forecast time, i.e. a second forecast time, of another elevator 110A-110C, 120A-120C, 130A-1300, i.e. a second candidate elevator, among the elevators 110A-110C, 120A-120C, 130A-130C of the selected sub-group A, B, C for providing service for the service call. More specifically, the group controller 150 may be arranged to evaluate if the other elevator, i.e. the second candidate elevator, may provide the service sooner than the first candidate elevator. In other words, it may be compared if the second forecast time is less than the first forecast time, and if that is the case the second candidate elevator may be selected 240 as the candidate to perform the service. On the other hand, if the second forecast time is larger than the first forecast time, the evaluation may be continued by taking the elevators in the selected sub-group as candidates in the described manner. For sake of completeness, it may be worthwhile to mention that a status of the elevators in the sub-group vary in response to completing earlier service calls, and, hence, the iteration of the evaluation is advantageous as long as it is allowed i.e. the locking criterion is not fulfilled.

The above described method according to an example embodiment allows controlling passenger flow in a building wherein a group of elevators may be divided into sub-groups A, B, C of elevators. The selection of the sub-group A, B, C is indicated to the passenger and the selection of individual elevator for taking the service call is continued until a predefined criterion is fulfilled and the selection must be locked to.

In the description of some example embodiments it is mainly referred to a provision of the service call as a form of a destination call. However, the present invention is not limited to such type of service call only. Namely, in some other example embodiments the service call may e.g. be given in a form of a landing call. In such embodiments the service call may e.g. carry some other information, such as an identifier of the user, or a user group, for whom an applicable sub-group A, B, C may be defined in a system data and, hence, selected in response to a receipt of the landing call as described. As a non-limiting example a solution may be mentioned in which the landing call is given, at least in part, with a device identifying the user in some extent, such as showing a tag or a magnetic card to a reader device e.g. implementing a function of the service call giving device 160 at least in part at a hall, which interaction generates a landing call to at least one elevator in a respective sub-group A, B, C of elevators so as to allow the operation in accordance with the present invention. In other words, the elevator group controller 150 performs the selection of the sub-group A, B, C based on data carried in the service call either directly or indirectly e.g. by inquiring the sub-group A, B, C for a user or a user group in question from data storage based on data received in the service call.

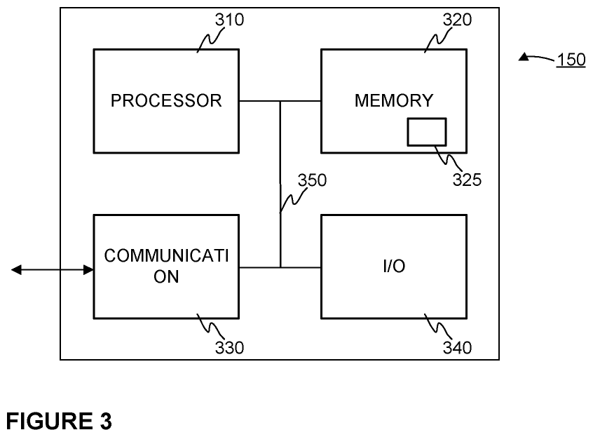

For example, the group controller 150 configured to execute the method according to an example embodiment may refer to an apparatus as schematically illustrated in FIG. 3. The device may be arranged to perform a control of a passenger flow in a building in a manner as described. FIG. 3 illustrates schematically as a block diagram a non-limiting example of the apparatus applicable to perform the method. The block diagram of FIG. 3 depicts some components of a device that may be employed to implement an operation of the group controller 150. The apparatus comprises a processor 310 and a memory 320. The memory 320 may store data and computer program code 325. The apparatus may further comprise communication means 330 for wired and/or wireless communication with other entities, such as other systems and/or devices forming the entities as described, like elevators in the sub-groups, as well as databases and similar. Furthermore, I/O (input/output) components 340 may be arranged, together with the processor 310 and a portion of the computer program code 325, to provide a user interface for receiving input from a user and/or providing output to the user of the system when necessary. In particular, the user I/O components may include user input means, such as one or more keys or buttons, a keyboard, a touchscreen, or a touchpad, etc. The user I/O components may include output means, such as a display or a touchscreen. The components of the apparatus may be communicatively coupled to each other via a bus 350 that enables transfer of data and control information between the components.

The memory 320 and a portion of the computer program code 325 stored therein may be further arranged, with the processor 310, to cause the apparatus, i.e. the device to perform a method as described in the foregoing description. The processor 310 may be configured to read from and write to the memory 320. Although the processor 310 is depicted as a respective single component, it may be implemented as respective one or more separate processing components. Similarly, although the memory 320 is depicted as a respective single component, it may be implemented as respective one or more separate components, some or all of which may be integrated/removable and/or may provide permanent/semi-permanent/dynamic/cached storage.

The computer program code 325 may comprise computer-executable instructions that implement functions that correspond to steps of the method when loaded into the processor 310. As an example, the computer program code 325 may include a computer program consisting of one or more sequences of one or more instructions. The processor 310 is able to load and execute the computer program by reading the one or more sequences of one or more instructions included therein from the memory 320. The one or more sequences of one or more instructions may be configured to, when executed by the processor 310, cause the apparatus to perform the method be described. Hence, the apparatus may comprise at least one processor 310 and at least one memory 320 including the computer program code 325 for one or more programs, the at least one memory 320 and the computer program code 325 configured to, with the at least one processor 310, cause the apparatus to perform the method as described.

The computer program code 325 may be provided e.g. a computer program product comprising at least one computer-readable non-transitory medium having the computer program code 325 stored thereon, which computer program code 325, when executed by the processor 310 causes the apparatus to perform the method. The computer-readable non-transitory medium may comprise a memory device or a record medium such as a CD-ROM, a DVD, a Blu-ray disc, or another article of manufacture that tangibly embodies the computer program. As another example, the computer program may be provided as a signal configured to reliably transfer the computer program.

Still further, the computer program code 325 may comprise a proprietary application, such as computer program code for executing the control of the passenger flow in the manner as described.

Any of the programmed functions mentioned may also be performed in firmware or hardware adapted to or programmed to perform the necessary tasks.

Moreover, as mentioned a functionality of the device implementing the group controller may be shared between a plurality of devices as a distributed computing environment. For example, the distributed computing environment may comprise a plurality of devices as schematically illustrated in FIG. 3 arranged to implement the method in cooperation with each other in a predetermined manner. For example, each device may be arranged to perform one or more method steps and in response to a finalization of its dedicated step it may hand a continuation of the process to the next device.

For sake of clarity it is worthwhile to mention that in the description of some aspects of the present invention it is mainly indicated that the apparatus performing at least some operations is the group controller of the elevator system. However, the operation may be performed by any other apparatus than the group controller integrable to the elevator system as described.

The aspects of the invention are mainly described in a building environment, but the term building in the context of the present invention shall be understood to cover any other spaces suitable for implementing the invention in the described manner.

The specific examples provided in the description given above should not be construed as limiting the applicability and/or the interpretation of the appended claims. Lists and groups of examples provided in the description given above are not exhaustive unless otherwise explicitly stated.

1. A method for controlling a passenger flow in a building comprising a group of elevators belonging to an elevator system, the method, performed by a group controller of the elevator system, comprises:
dividing the group of elevators to sub-groups of elevators,
receiving a service call,
selecting a sub-group among the sub-groups of elevators to provide a service for the service call and generating an indication for indicating the sub-group selected for the service call,
selecting a first candidate elevator from the elevators of a selected sub-group to provide the service for the service call within a first forecast time,
evaluating a second candidate elevator from the elevators of a selected sub-group to provide the service for the service call within a second forecast time by comparing the second forecast time to the first forecast time,
selecting the second candidate elevator from the elevators of a selected sub-group to provide the service for the service call if the second forecast time is less than the first forecast time,
wherein the method the evaluation is continued until a selection of the candidate elevator is locked for the service call due to at least one characteristic relating to the elevator system.

2. The method of claim 1, wherein a selection of the sub-group among the sub-groups of elevators to provide a service is performed based on at least one of: a destination floor indicated in the service call; identification of a user or a user group from data associated to the service call; identification of a service call giving device wherefrom the service call is received; allocations status of service calls between the sub-groups of elevators; a prediction model defining a selection of the sub-group of elevators.

3. The method of claim 1, the method further comprising: generating a control signal to cause an indication for indicating the locked candidate elevator selected from the elevators of the selected sub-group to serve the service call.

4. The method of claim 3, wherein the indication is caused to be generated at least by an elevator indicator of candidate elevator locked for the service.

5. The method of claim 1, wherein the at least one characteristic relating to the elevator system is at least one of: a deceleration of the elevator car of the candidate elevator is initiated; a predefined advance indication time defining an instant of time prior to a landing of the elevator car of the candidate elevator the indication for indicating the locked candidate elevator is generated.

6. The method of claim 1, wherein a division of the group of elevators to sub-groups is performed as at least one of: static configuration for the elevator system; dynamically.

7. The method of claim 1, wherein a generation of the indication of the sub-group is performed by causing an output of the indication by at least one of: an elevator call giving device; a sub-group indicator.

8. A group controller of an elevator system comprising a group of elevators, the group controller is arranged to perform:
divide the group of elevators to sub-groups of elevators,
receive a service call,
select a sub-group among the sub-groups of elevators to provide a service for the service call and generating an indication for indicating the sub-group selected for the service call,
select a first candidate elevator from the elevators of a selected sub-group to provide the service for the service call within a first forecast time,
evaluate a second candidate elevator from the elevators of a selected sub-group to provide the service for the service call within a second forecast time by comparing the second forecast time to the first forecast time,
select the second candidate elevator from the elevators of a selected sub-group to provide the service for the service call if the second forecast time is less than the first forecast time,
wherein the group controller is arranged to continue an evaluation until a selection of the candidate elevator is locked for the service call due to at least one characteristic relating to the elevator system.

9. The group controller of the elevator system, wherein the group controller is further arranged to perform a selection of the sub-group among the sub-groups of elevators to provide a service based on at least one of: a destination floor indicated in the service call; identification of a user or a user group from data associated to the service call; identification of a service call giving device wherefrom the service call is received; allocations status of service calls between the sub-groups of elevators; a prediction model defining a selection of the sub-group of elevators.

10. The group controller of the elevator system of claim 8, wherein the group controller is further arranged to perform: generate a control signal to cause an indication for indicating the locked candidate elevator selected from the elevators of the selected sub-group to serve the service call.

11. The group controller of the elevator system of claim 10, wherein the indication is caused to be generated at least by an elevator indicator of candidate elevator locked for the service.

12. The group controller of the elevator system of claim 8, wherein the at least one characteristic relating to the elevator system is at least one of: a deceleration of the elevator car of the candidate elevator is initiated; a predefined advance indication time defining an instant of time prior to a landing of the elevator car of the candidate elevator the indication for indicating the locked candidate elevator is generated.

13. The group controller of the elevator system of claim 8, wherein the group controller is further arranged to perform a division of the group of elevators to sub-groups as at least one of: static configuration for the elevator system; dynamically.

14. The group controller of the elevator system of claim 8, wherein the group controller is further arranged to perform a generation of the indication of the sub-group by causing an output of the indication by at least one of: an elevator call giving device; a sub-group indicator.

15. A non-transitory computer readable medium comprising computer readable program code configured to cause performing the method according to claim 1 when said program code is run on one or more computing apparatuses.

16. An elevator system, comprising:
a group of elevators, and
a group controller according to claim 8.
